(19) United States
(12) Patent Application Publication
(10) Pub. No.: US 2020/0104476 A1
(43) Pub. Date: Apr. 2, 2020

(54) METHOD FOR PROTECTING A CAMERA AND A MICROPHONE FROM UNAUTHORIZED ACCESS

(71) Applicant: KROMTECH ALLIANCE CORP., Road Town (VG)

(72) Inventors: VIKTOR RADULOV, Kyiv (UA); VOLODYMYR SHELEST, Kyiv (UA)

(21) Appl. No.: 16/513,284

(22) Filed: Jul. 16, 2019

Related U.S. Application Data
(63) Continuation-in-part of application No. 16/203,935, filed on Nov. 29, 2018, now Pat. No. 10,395,066.

(30) Foreign Application Priority Data
Sep. 28, 2018 (UA) A 2018 09723

(51) Int. Cl. G06F 21/44

(52) U.S. Cl. CPC G06F 21/44

(57) ABSTRACT

The invention relates to digital data processing systems that use a microphone and/or a camera as a means of inputting information. More particularly, the invention relates to the security and protection of computers or computer systems from unauthorized actions by controlling access to a microphone and/or a camera from software applications that request access to the function of a microphone and/or camera.

A method for protecting a camera from unauthorized access comprises subscribing to an event of request for access to files of a computer system, identifying a process requesting camera access file, determining whether said process is allowed, permit access allowed process to the camera. The subscribing comprises callback about all events of request for access to files of the computer system and filtering the camera access files. The identifying a process requesting camera access file comprises reception of an access path to the file and identificator of the process. The determining whether said process is allowed comprises a determination, if the file is a camera access file, using the access path to the file, and checking if the process in the whitelist or in the blacklist using identificator of the process. If the process requesting access to the camera's access file is unknown then said process is freeze and a user is notified about this. If the user allows permit access to the camera, the process is unfrozen and access to the file is permit. A computer information processing system and tangible non-transitory machine-readable medium are described too.

### CROSS-REFERENCE TO RELATED APPLICATIONS

This application is a continuation-in-part of U.S. application Ser. No. 16/203,935, filed Nov. 29, 2018, which claims priority to Ukrainian Application No. a 2018 09723, filed Sep. 28, 2018; which are hereby incorporated by reference in their entirety.

### FIELD OF THE INVENTION

The invention relates to digital data processing systems that use a camera as a means of inputting information. More particularly, the invention relates to the security and protection of computers or computer systems from unauthorized actions by controlling access to a camera from software applications that request access to the function of a camera.

### BACKGROUND OF THE INVENTION

The problem for the computer system security from software applications using functions of cameras of the computer system through an operating system is known in the art. The danger lies in possible unauthorized access to the functions of a camera from a software application. As a result, the computer system can capture a sound and/or image without the user's knowledge, including remotely. Audio and/or video data so collected may be transmitted outside the computer system over Internet channels using data exchange and providing protocols known in the art. In this case, a user may not even notice an unauthorized use of the cameras, given a very short time of access to the function of these devices.

The said problem of controlling access to the camera function is solved by identifying processes (software applications) that request access to the camera function followed by the use of the camera access permissions system for the identified processes (software applications). To request access, processes receive information on cameras available in a computer system through elements of an operating system. If they receive information on the availability of a camera in the system, a process tries to get access and start recording video and/or audio (to create a media stream). When no permission is given, the process is identified and a message of the impossibility to start recording through a camera is sent. Thus, the access to the function of a camera is controlled by controlling media streaming.

A similar approach is disclosed in US20130286225A1 dd. Oct. 31, 2013, where a media stream (of video and/or audio data) from a camera upon request of the process (software application) is blocked using a low level filter driver the computer system is equipped with. Said driver is blocked by default and may be unblocked from the side of a computer system user, once the user has been informed of the created media stream, or may be unblocked automatically. In this case, the information on cameras available in the computer system is accessible to all processes (software applications) operating in the computer system, and the unauthorized receipt of video and/or audio data is terminated by controlling the access to a media stream created by the camera, with the process informed of the availability of the camera and requesting access to its functions.

In some cases, such an approach leads to the termination of recording through a camera well after a media streaming was started. This can lead to short-term unauthorized capture of a sound and/or image without the user's knowledge and breach of the computer system security.

Therefore, solutions are required to secure the computer system and inhibit unauthorized capture of a sound and/or image at a lower level, for example, not by controlling requests of processes (software applications) to access the functions of the camera, but rather by controlling the access of processes (software applications) to information about the availability of cameras in the computer system. That is, the process (software application) will not be able to access the functions of the camera because with the first request the process (software application) will receive information about the unavailability of the camera in the computer system and will be able to get access once a user has given his/her separate permission depending on his/her decision and the information about cameras available in the computer system has been sent. In addition, the process (software application) will not be able to start recording via the microphone because with the first request the process (software application) will be «frozen»/blocked.

### SUMMARY OF THE INVENTION

Embodiments of the present invention provide a method for protecting a camera from unauthorized access and a computer information processing system wherein said method for protecting a camera from unauthorized access is implemented, as well as a tangible non-transitory machine-readable media equipped with a set of instructions for a computer system processor to protect the camera from unauthorized access in accordance with said method. To achieve this, the following technical solutions are possible.

The invention is intended to inhibit unauthorized use of a camera in a computer system by third-party software applications.

The technical result of the invention is the determination of software applications/processes (hereinafter referred to as applications/processes) that use functions of a camera, preferably on Mac OS (Apple Inc©), with an option to block such applications/processes.

According to one aspect of the present invention, there is provided a method for protecting a camera from unauthorized access comprising subscribing to an event of request for access to files of a computer system, identifying a process requesting camera access file, determining whether said process is allowed, permit access allowed process to the camera.

In one embodiment of the method, the subscribing comprises callback about all events of request for access to files of the computer system and filtering the camera access files.

According to another embodiment of the method, the identifying a process requesting camera access file comprises reception of an access path to the file and identificator of the process.

According to yet another embodiment of the method, the determining whether said process is allowed comprises a determination, if the file is a camera access file, using the access path to the file.

According to yet another embodiment of the method, the determining whether said process is allowed comprises forming a list of allowed processes (whitelist) or a list of forbidden process (blacklist).

According to yet another embodiment of the method, the determining whether said process is allowed comprises checking if the process in the whitelist or in the blacklist using identificator of the process.

According to yet another embodiment of the method, if the process requesting access to the camera's access file is unknown then said process is freeze.

According to yet another embodiment of the method, the determining whether said process is allowed comprises notification of a user of the computer system about freezing process.

According to yet another embodiment of the method, the forming the whitelist or the blacklist comprises adding of new processes including freezing processes.

According to yet another embodiment of the method, new added process is unfreeze if new added process has been running.

According to the second aspect of the invention, there is provided a computer information processing system comprising a computing system with at least one processor and a tangible non-transitory machine-readable medium coupled thereto. The tangible non-transitory machine-readable medium comprising an operating system, a set of instructions implemented by the at least one processor, and a subsystem for control of access to a camera coupled to the computer system. The subsystem comprising a control module adapted to inform user about event of the computer system, and a process service module that controls processes of computer system requests to access cameras. The process service module is connected to the control module. The process service module adapted to subscribing to an event of request for access to files of a computer system from a kernel authorization subsystem of the computing system and an identifying a process requesting camera access file. The process service module connected with at least one list of allowed processes (whitelist) and/or at least one list of forbidden process (blacklist). The process service module adapted to a determining whether said process is allowed and permit access allowed process to the camera or freeze an unknown process. The process service module adapted to inform the control module about unknown process. The control module adapted to inform a user of the computer system about unknown process and inform the process service module about unfreeze the unknown process.

In one embodiment of the computer system, the process service module have access path to the camera access file via the kernel authorization subsystem of the computer system.

According to another embodiment of the computer system, the process service module adapted to filtering the camera access files from all modified computer system files, using the access path to the file.

According to yet another embodiment of the computer system, the control module adapted to add new process in the whitelist and the blacklist or remove the process from the whitelist and the blacklist.

According to the second aspect of the invention, there is provided at least one tangible non-transitory machine-readable media comprising a set of commands implemented by a computer system processor: subscribing to an event of request for access to files of a computer system, identifying a process requesting camera access file, determining whether said process is allowed, permit access allowed process to the identified camera.

In one embodiment, the machine-readable media further comprises a filtering the requests for access to files of the computer system by a reception of an access path to the file and identificator of the process and a determination, if the file is a camera access file, using the access path to the file.

According to yet another embodiment, the machine-readable media further comprises a forming a list of allowed processes (whitelist) or in a list of forbidden process (blacklist).

According to yet another embodiment, the machine-readable media further comprises a checking if the process in the whitelist or in the blacklist using identificator of the process.

According to yet another embodiment, the machine-readable media further comprises a freezing unknown process requesting access to the camera access file and a notification of a user of the computer system about freezing process.

According to yet another embodiment, the machine-readable media further comprises an adding of new processes to the whitelist or the blacklist including freezing processes.

According to yet another embodiment, the machine-readable media further comprises an unfreezing new process added to the whitelist or the blacklist if new added process has been running.

Unlike solutions where access to a camera function is controlled by identifying processes that access a camera in the user system, the proposed solution provides a possibility to block such processes at a low level without allowing the processes to access the camera at all. Further, the present invention provides that all processes using a camera have access to information on the availability of cameras in a computer system only through a separate subsystem that controls access to a camera coupled to a computer system that is one of the objects of this invention. Still further, the proposed invention provides the possibility to generally control access to all cameras coupled to a computer system. For example, a computer system (such as a laptop or a similar device as described more specifically below) is equipped with a built-in camera and coupled to an external camera. Said access control subsystem makes the external camera invisible to all processes (hides the external camera), while the internal camera is left available, or vice versa. The access control subsystem also provides the possibility to hide all the cameras in the computer system. Therefore, any process requesting access to the camera through the operating system will have to obtain permission from said access control subsystem first. The access control subsystem will notify a computer system user accordingly. If the user gives a command to permit the process to access the camera, the access control subsystem provides the process with the information about cameras connected to the computer system and allows the process to access the camera.

With the proposed solution, no process sees cameras available in the system. All process requests to access the camera pass through the access control subsystem and, at first, the process receives information on the unavailability of the device it requests. That is, unlike the solutions known in the art that control access to a media stream, which has been already created through the camera, the proposed solution allows first to hide the availability of a camera in a computer system from a process. Access control at such a low level increases the computer system security on the side of software applications, which use the functions of cameras, by disabling unauthorized media streaming, even for a short period of time.

In the process of testing the solution to block unauthorized access to the camera, it was discovered that the media stream (recording video and/or audio) in a computer system (especially, in Mac OS) is divided immediately between all the processes that were granted access. For example, if access to the camera was granted to three processes, then in case of activation of the camera and creation of a media stream, this media stream will be available to all three processes. Under certain conditions, this media stream may become available to the fourth process, which was not granted access to the camera. Moreover, the unauthorized process can gain access to this media stream bypassing the access control subsystem, because of the computer system (MacOS) already distributes this media stream to all processes that had previously been accessed. That is, the media stream can be distributed by an abuser in circumvention of aforementioned low level access control. Avoid danger of this case, some improvement proposed.

The improvements is as follows. Via a subscribing to all operations (read/write/change) of all files in the computer system, the subsystem for control of access to a camera and a microphone tracks the activity of processes, namely, finds all processes that requests operation with the files. Further, filtering the files is performed to identify a process requesting camera access files. The filtering is performed by the subsystem for control of access to a camera and a microphone. The camera access files is files that are responsible for recording a camera and distributing a media stream. The tracking only these files identifying a process requesting access to a camera. After an identification of the process requesting access to a camera the subsystem for control of access to a camera and a microphone blocks or allows access to a camera.

It is to be understood that both the foregoing general description and the following detailed description are merely exemplary and explanatory and are not restrictive of the claimed invention.

### BRIEF DESCRIPTION OF THE DRAWINGS

The accompanying drawings are incorporated in and constitute a part of this description of the invention. The drawings illustrate embodiments and, together with the description, serve to explain principles of the invention.

FIG. 1 illustrates a diagram showing a computer system wherein a method for protecting a camera from unauthorized access is implemented in accordance with some illustrative embodiments of the invention;

FIG. 2 illustrates a flowchart showing a subsystem, installed on a tangible non-transitory machine-readable media, which controls access to a camera and a microphone coupled to a computer system;

FIG. 3 illustrates a flowchart showing an algorithm of how said access control subsystem operates when access to a camera is requested;

FIG. 4 illustrates a flowchart showing an algorithm of change the camera access configuration of said access control subsystem.

### DETAILED DESCRIPTION

Illustrative embodiments are described in detail below with reference to the accompanying drawings. The illustrative embodiments described below are in no way intended to cover all possible embodiments of the invention but serve to further explain the disclosure of the invention.

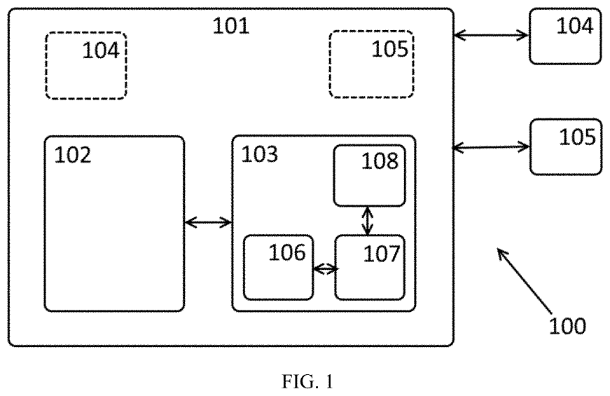

FIG. 1 illustrates a diagram demonstrating a computer system wherein a method for protecting a camera from unauthorized access is implemented in accordance with some illustrative embodiments of the invention.

According to FIG. 1, a computer system 100 comprises a computing device 101 with one or more processors 102 and a tangible non-transitory machine-readable media 103 coupled to the computing device 101. The computing device 101 may be a personal computer, a portable computer (laptop) and similar devices, such as those manufactured by Apple Inc©, e.g. iMac, MacBook and other similar devices, equipped with means for inputting information to the computer system 100 (a keyboard, touch pad, computer mouse, etc.) or configured so that such means can be connected thereto, and means for outputting information (a screen, speakers, etc.). Means of inputting information include means for inputting visual and audio information, such as a camera 104, and audio information, such as a microphone 105. The camera 104 or the microphone 105 may be built-in in the computing device 101, e.g. a camera and a microphone of a desktop or laptop computer. The camera 104 and the microphone 105 may be external devices connected through a serial interface to the computing device 101, e.g. a USB camera or an external microphone, a headset for IP telephony, and the like. The processor 102 may be an Ax processor (Apple Inc©) or Ivy Bridge, Haswell, Skylake processor (Intel Core©) and the like. The machine-readable media 103 comprises an external memory of the computer system 100, e.g. solid state drive (SSD), for storing software applications and data 106. The machine-readable media 103 also comprises internal memory that contains non-volatile read-only memory (ROM) and random-access memory (RAM) configured to store a set of instructions performable by the processor 102. The machine-readable media 103 is equipped with an operating system 107, e.g. Mac OS (Apple Inc©). Said set of instructions includes, in particular, a sequence of operations using the functions of the camera 104 and/or microphone 105 on the side of the operating system 107 and software applications 106. Examples of software applications may include Skype©/Telegram©/Facetime© or other similar software applications that request access to the microphone or camera functions. In particular, said set of instructions permits all steps of the operation of the subsystem that controls access to the camera and microphone coupled to the computer system 108 located on the tangible non-transitory machine-readable media103.

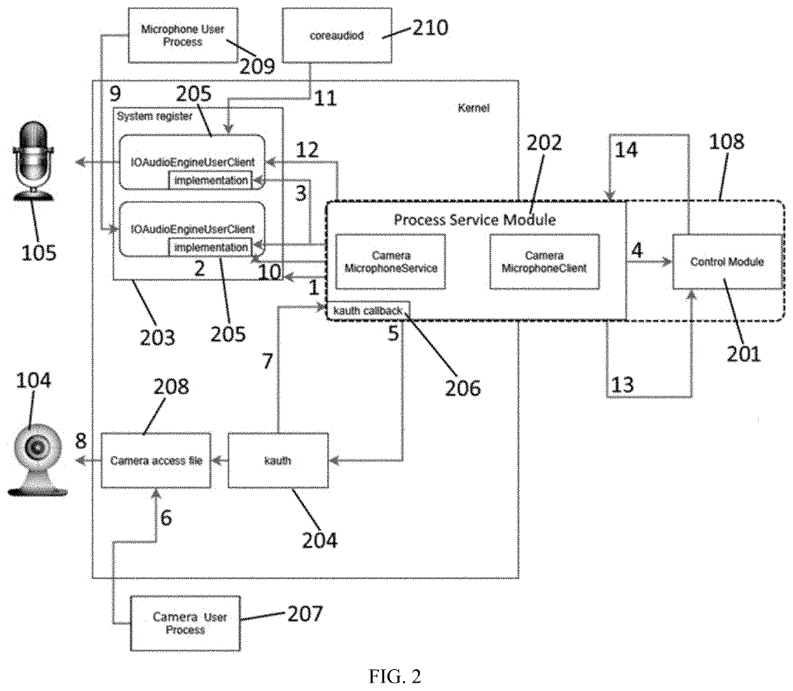

FIG. 2 illustrates the subsystem that controls access to the camera and microphone coupled to the computer system 108 used for the computer system 100 equipped with MacOS (Macintosh Operating System) developed by Apple Inc. According to FIG. 2, the subsystem that controls access to the camera and microphone coupled to the computer system 108 comprises a control module 201 and a process service module 202. The process service module 202 is a module that controls processes of computer system requests to access audio devices and cameras. The process service module 202 connected to the control module 201. The subsystem that controls access to the camera and microphone coupled to the computer system 108 may, together with said components, be installed as a software application on the tangible non-transitory machine-readable media 103 together with the operating system 107.

The control module 201 adapted to inform user about event of the computer system 100. The control module 201 is suitable for accessing records of a system registry of computer system devices 203. The control module 201 is suitable for automatic obtaining data on new identifiers of cameras 104 created in the computer system 100 from the system registry of computer system devices 203 and for transmitting the data so obtained to the process service module 202. The control module 201 is adapted to inform a user of the computer system 100 about unknown process and inform the process service module 202 about unfreeze the unknown process.

The process service module 202 controls processes of computer system requests to access cameras 104. The process service module 202 adapted to subscribing to an event of request for access to files of a computer system 100 from a kernel authorization subsystem 204 of the computer system 100 (Kernel AUTHorization (KAuth) subsystem 204). The process service module 202 adapted to receipt access path to the camera access file via the kernel authorization subsystem 204. The process service module 202 adapted to identifying a process requesting camera access file. For this purpose, the process service module 202 adapted to filtering the camera access files from all modified computer system files, using the access path to the file. The process service module 202 connected with at least one list of allowed processes (whitelist) and at least one list of forbidden process (blacklist). The process service module 202 adapted to a determining whether the process, which requests to access cameras 104, is allowed and permit access allowed process to the camera 104 or freeze an unknown process. The process service module 202 adapted to inform the control module 201 about unknown process. The process service module 202 can itself have a modular structure and comprise components (modules) such as CameraMicrophoneService and CameraMicrophoneClient (FIG. 2) with the CameraMicrophoneService module of the process service module 202 being connected to the control module 201 through the CameraMicrophoneClient module.

The flowchart in FIG. 2 also shows the steps of controlling access to the camera 104 and the microphone 105 connected to the computer system to protect them against unauthorized access using the subsystem 108 described above.

At step 1, the process service module 202 determines a list of audio devices connected to the computer system 100 with the help of the system registry of computer system devices 203. The determination of the list of audio devices means the acquisition of data on all IOAudioEngineUserClient objects 205 (all audio devices, i.e. audio devices capable of recording or replaying and processing audio data) by the process service module 202.

The determination of the list of audio devices of the computer system 100 involves the subsequent tracking of new records created in the system registry 203 about a new audio device in the computer system 100 (step 2). For this purpose, the process service module 202 is subscribed to information on the creation of new IOAudioEngineUserClient objects 205 by continuous monitoring of the list of devices in the system registry 203 by the process service module 202. If a new device is connected to the computer system 100, a new record is created in the system registry 203 whereof is automatically notified to the process service module 202.

After the process service module 202 receives the list of audio devices in the computer system 100, step 3 is performed, at which the implementation of the list of audio devices is replaced by the implementation through the process service module 202, which provides the initial functionality of said devices and additional screening of the application/process requesting access to the functions of the microphone through the access control subsystem 108. The implementation of the device means a set of instructions whereby the data between the devices, in particular, audio devices, and the computer system 100 are exchanged. The access control subsystem 108 essentially replaces this set of instructions and starts to function as ‘a relay’ which disables and enables a data exchange chain between the devices and the computer system 100. After the substitution of the implementation, any request of a device to the system or of the system to the device is given through the process service module 202, which has the function of authorizing or prohibiting the request so received. Therefore, the implementation of functions of audio devices and the request to access their functions from the side of applications/processes is necessarily carried out through the process service module 202, which serves as the first and necessary link in the data exchange chain between the devices and the computer system 100. At step 4, the CameraMicrophoneService of the process service module 202 connect to the control module 201 via CameraMicrophoneClient of the process service module 202.

The flowchart in FIG. 2 shows steps 5-8 which provide protection against unauthorized access for the camera 104. Thus, at step 5, the process service module 202 subscribes to an event of request for access to files of a computer system 100 by means of the kernel authorization subsystem (kauth) 204. The subscribing is carried out by calling kauth function ‘kauth_listen scope’, which have parameter ‘KAUTH_SCOPE_VNODE’ and kauth callback function 206.

At step 6, a process that will use the camera 104 (the Camera User Process 207) requests to the camera access file 208.

At step 7, the kernel authorization subsystem 204 send an information about the Camera User Process 207 to the process service module 202 by kauth callback 206. The information includes an access path to the camera access file 208 and identificator of the Camera User Process 207.

At step 8, the process service module 202 permits access allowed the process 207 to the camera 104 or block forbidden or unknown the Camera User Process 207.

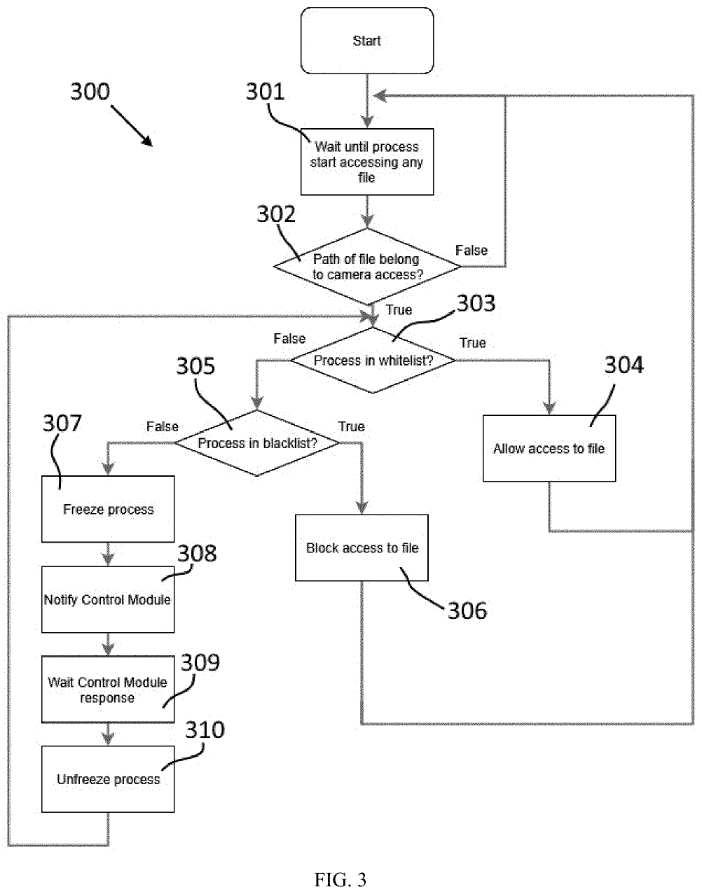

An illustrative embodiment of blocking access for applications/processes to the camera 104 using the proposed method is shown by the flowchart of the algorithm 300 in FIG. 3.

As shown in FIG. 3, the method for protecting the camera from unauthorized access may involve the following steps.

At step 301, the process service Module 202 waits for an information from kauth callback 206. If some process start (for example, the Camera User Process 207) accessing any file of the computer system 100, the process service module 202 receive an access path to the file and identificator of the Camera User Process via kauth callback 206.

At step 302, the process service module 202 defines if the file is a camera access file 208, using the access path to the file. If the access path is in a list of path for known camera processes than the method for protecting the camera from unauthorized access goes to the next step.

At step 303, the process service module 202 checks if the Camera User Process 207 in the whitelist or in the blacklist using identificator of the process. If the Camera User Process 207 is in the whitelist, the process service module 202 allows access (KAUTH_RESULT_ALLOW) to camera access file 208 (step 304). If the Camera User Process 207 is in the blacklist (step 305), the process service module 202 blocks access to camera access file 208 (step 306). If the Camera User Process 207 is not on the whitelist and on the blacklist (i.e., the process is unknown) then said process is freeze (step 307).

At step 308, the process service module 202 notifies the control module 201 about freezing process.

At step 308, the control module 201 notifies the user of the computer system about freezing process and wait for user's response. The process service module 202 still wait for response of the control module 201 (step 309).

If user allows the frozen process, the control module 201 notifies the process service module 202 about user's response and the process service module 202 unfreezes unknown process (step 310). At that, user can form the whitelist and the blacklist via the control module 201 during the determination whether the process is allowed. The forming the whitelist or the blacklist comprises adding of new processes including freezing processes. If new added process has been running new added process is unfreeze and then the method for protecting the camera from unauthorized access starts with step 303.

Unlike camera protection, in case of microphone access control, microphones are not identified among all audio devices obtained at step 1 according to FIG. 2. Whether the device to which the process requests access is a microphone is determined at the moment of audio streaming. If the audio streaming is a sound recording process, the audio streaming device is then defined as a microphone.

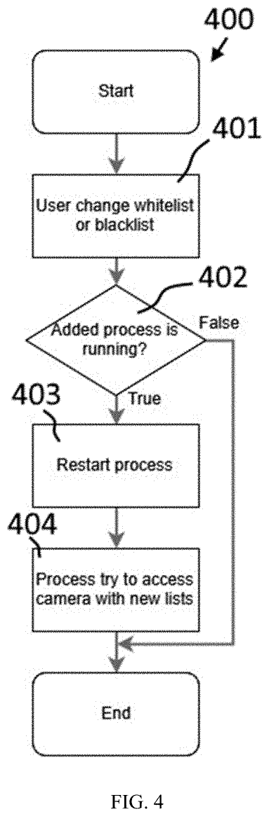

An illustrative embodiment of an algorithm of change the camera access configuration of said access control subsystem 108 is shown by the flowchart of the algorithm 400 in FIG. 4.

As shown in FIG. 4, the change the camera access configuration may involve the following steps.

At step 401, the user changes the whitelist or the blacklist by addition or removal processes.

If added process is running (step 402), the process is restarting (step 403). After restarting, the process start access to the camera again using changed the whitelist or the blacklist (step 404).

The flowchart in FIG. 2 shows steps 9-14 that provide protection of the microphone 105 against unauthorized access. Thus, at step 9, the process 209 (Microphone User Process), which requests access to the microphone 105, creates a record in the IOAudioEngineUserClient 205 branch of the system registry 203.

At step 10, last record information on the process 209 requesting access to the microphone from the IOAudioEngineUserClient 205 branch of the system registry 203 is stored using the process service module 202.

At step 11, the process tries to start the sound recording by creating an appropriate record in the branch of the IOAudioEngineUserClient 205 using the system element coreaudiod 210. Coreaudiod 210 is a Mac OS system element through which sound recording is initiated by all processes. For this purpose, coreaudiod 210 creates its record in the IOAudioEngineUserClient 205 branch of the system registry 203.

At step 12, the process service module 202 screens the sound recording process 209 through the microphone 105 against the whitelist according to the last stored record information and opens access to the microphone 105 for the whitelisted process 209 or blocks the sound recording through the microphone 105 for the unknown process 209, which is not on the whitelist. The process service module 202 may also disable the microphone 105 if the process 209 is on the process blacklist.

At step 13, the process service module 202 sends to the control module 201 a message of the intention to connect the process to the microphone 105. The control module 201 informs the user of a sound recording process which is not on the process whitelist.

At step 14, the control module 201 provides the user with information about the process/processes requesting access to the microphone 105. Depending on subsequent user's choice, the control module 201 sends a process whitelist to the process service module 202. Thus, the sound recording process, which is not on the whitelist, is added to the whitelist or the process recording sound through the microphone 105 is blocked.

The method described above can be explained in practice by the example of its specific application in the computer system 100, with the computing device 101 equipped with the access control subsystem 108 and with Skype© installed on the tangible non-transitory machine-readable media, and the software application Skype© has the function of accessing the camera 104 and the microphone 105.

Skype© intends to access the camera 104 installed on the computer system 100. For this purpose, Skype© (the process) refers to the camera access file 208 to connect it as a library. The process service module 202 checks if the process can access the file in this path. If the process is not whitelisted or blacklisted, then the process is frozen. After that, the process service module 202 notifies the control module 201 about the process requesting camera access file 208. The control module 201 notifies the user thereof. If the user allows permit access to the camera, the process is unfrozen and access to the file is permit. If the user denies access, the process is unfrozen but without access to the camera access file 208, which is equivalent to the absence of any cameras in the computer system 100.

1. A method for protecting a camera from unauthorized access comprising:
subscribing to an event of request for access to files of a computer system,
identifying a process requesting camera access file,
determining whether said process is allowed,
permit access allowed process to the camera.

2. The method of claim 1 wherein the subscribing comprises callback about all events of request for access to files of the computer system and filtering the camera access files.

3. The method of claim 1 wherein the identifying a process requesting camera access file comprises reception of an access path to the file and identificator of the process.

4. The method of claim 3 wherein the determining whether said process is allowed comprises a determination, if the file is a camera access file, using the access path to the file.

5. The method of claim 4 wherein the determining whether said process is allowed comprises forming a list of allowed processes (whitelist) or a list of forbidden process (blacklist).

6. The method of claim 5 wherein the determining whether said process is allowed comprises checking if the process in the whitelist or in the blacklist using identificator of the process.

7. The method of claim 6 wherein if the process requesting access to the camera's access file is unknown then said process is freeze.

8. The method of claim 7 wherein the determining whether said process is allowed comprises notification of a user of the computer system about freezing process.

9. The method of claim 5 wherein the forming the whitelist or the blacklist comprises adding of new processes including freezing processes.

10. The method of claim 9 wherein new added process is unfreeze if new added process has been running.

11. A computer information processing system comprising a computing system with at least one processor and a tangible non-transitory machine-readable medium coupled thereto, the tangible non-transitory machine-readable medium comprising an operating system, a set of instructions implemented by the at least one processor, and a subsystem for control of access to a camera coupled to the computer system, the subsystem comprising:
a control module adapted to inform user about event of the computer system, and
a process service module that controls processes of computer system requests to access cameras and is connected to the control module,
wherein:
the process service module adapted to subscribing to an event of request for access to files of a computer system from a kernel authorization subsystem of the computing system and an identifying a process requesting camera access file,
the process service module connected with at least one list of allowed processes (whitelist) and/or at least one list of forbidden process (blacklist),
the process service module adapted to a determining whether said process is allowed and permit access allowed process to the camera or freeze an unknown process,
the process service module adapted to inform the control module about unknown process,
the control module adapted to inform a user of the computer system about unknown process and inform the process service module about unfreeze the unknown process.

12. The computer system of claim 11 wherein the process service module adapted to receive access path to the camera access file via the kernel authorization subsystem of the computer system.

13. The computer system of claim 12 wherein the process service module adapted to filtering the camera access files from all modified computer system files, using the access path to the file.

14. The computer system of claim 11 wherein the control module adapted to add new process in the whitelist and the blacklist or remove the process from the whitelist and the blacklist.

15. At least one tangible non-transitory machine-readable medium comprising a set of commands implemented by a computer system processor:
subscribing to an event of request for access to files of a computer system,
identifying a process requesting camera access file,
determining whether said process is allowed,
permit access allowed process to the identified camera.

16. The machine readable media of claim 15 further comprising a filtering the requests for access to files of the computer system by a reception of an access path to the file and identificator of the process and a determination, if the file is a camera access file, using the access path to the file.

17. The machine readable media of claim 15 further comprising a forming a list of allowed processes (whitelist) or in a list of forbidden process (blacklist).

18. The machine readable media of claim 17 further comprising a checking if the process in the whitelist or in the blacklist using identificator of the process.

19. The machine readable media of claim 18 further comprising a freezing unknown process requesting access to the camera access file and a notification of a user of the computer system about freezing process.

20. The machine readable media of claim 17 further comprising an adding of new processes to the whitelist or the blacklist including freezing processes.

21. The machine readable media of claim 20 further comprising an unfreezing new process added to the whitelist or the blacklist if new added process has been running.
